(19) United States
(12) Patent Application Publication
(10) Pub. No.: US 2007/0047521 A1
(43) Pub. Date: Mar. 1, 2007

(54) VOIP APPARATUS AND METHOD FOR DETECTING A PSTN SERVICE PROVIDED THERETO

(75) Inventors: IRAWAN KUNCORO, TU CHENG (TW); YU-CHENG LIN, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,581

(22) Filed: Apr. 8, 2006

(30) Foreign Application Priority Data
Aug. 26, 2005 (TW) 94129245

(51) Int. Cl. H04L 12/66

(52) U.S. Cl. 370/352

(57) ABSTRACT

A method for detecting a status regarding provision or otherwise of a public switched telephone network (PSTN) service to a voice over Internet protocol (VoIP) apparatus includes the steps of: providing a dummy load circuit and an off-hook detection circuit; entering a PSTN mode; coupling the dummy load circuit to a PSTN to simulate an off-hook status of a telephone set; detecting whether there is a dial tone from the PSTN by the off-hook detection circuit; and determining whether the PSTN service is provided to the VoIP apparatus according to a detection or otherwise of a dial tone from the PSTN. A VoIP apparatus employing the method is also provided.

### FIELD OF THE INVENTION

The present invention relates to voice over Internet protocol (VoIP), and particularly to a VoIP apparatus and method for detecting the existence and functioning status of a public switched telephone network (PSTN) service provided to the apparatus.

### DESCRIPTION OF RELATED ART

With the growing popularity of high-speed Internet connections, it is now common for voice over Internet protocol (VoIP) phone calls to be made over the Internet. The VoIP provides voice services over an Internet protocol (IP) network. With a VoIP service, voice information is converted to data packets, which are then transmitted over the IP network. One advantage of VoIP services is that VoIP phone calls are significantly cheaper than phone calls made over a public switched telephone network (PSTN). However, the voice quality of VoIP phone calls may be degraded by the quality of the particular network service used. Although PSTN phone calls are expensive, their voice quality is typically better than that of VoIP phone calls. Therefore, many Internet service providers (ISPs) provide not only VoIP services, but also PSTN services.

However, in general, it is problematic for an ISP to determine whether a PSTN service is also provided to a particular customer. Additionally, if an ISP provides both a VoIP service and a PSTN service to a customer, and if the customer experiences problems with the provision of voice service, it is important for the ISP to determine which particular service has problems, the PSTN service or the VoIP service. However, in general, it is difficult for the ISP to make such determination.

### SUMMARY OF INVENTION

One aspect of the present invention provides a voice over Internet protocol (VoIP) apparatus, for detecting whether a public switched telephone network (PSTN) service is provided to the apparatus, and if the PSTN service is provided, for detecting whether the PSTN service is functioning normally. The VoIP apparatus includes a main processor, a relay circuit, a dummy load circuit, and an off-hook detection circuit. The relay circuit is under control of the main processor, for selectively connecting a telephone set to the main processor or to a PSTN. The dummy load circuit is for coupling to the PSTN under control of the main processor, and for simulating an off-hook status of the telephone set. The off-hook detection circuit is for coupling to the PSTN under control of the main processor, and for detecting a dial tone from the PSTN. The main processor is used for determining the provision or otherwise of the PSTN service and the normal functioning or otherwise of the PSTN service according to a detection or otherwise of a dial tone from the PSTN.

Another aspect of the present invention provides a method for detecting a status regarding provision or otherwise of a public switched telephone network (PSTN) service to a voice over Internet protocol (VoIP) apparatus. The method includes the steps of: providing a dummy load circuit and an off-hook detection circuit; entering a PSTN mode; coupling the dummy load circuit to a PSTN to simulate an off-hook status of a telephone set; detecting whether there is a dial tone from the PSTN by the off-hook detection circuit; and determining whether the PSTN service is provided to the VoIP apparatus according to a detection or otherwise of a dial tone from the PSTN.

Other advantages and novel features will become more apparent from the following detailed description when taken in conjunction with the accompanying drawings, in which:

### BRIEF DESCRIPTION OF DRAWINGS

FIG. 1 is a block diagram of a Voice over Internet Protocol (VoIP) apparatus of an exemplary embodiment of the present invention; and

FIG. 2 is a flow chart of a method for detecting whether a PSTN service is provided to a VoIP apparatus such as the VoIP apparatus of FIG. 1, in accordance with an exemplary embodiment of the present invention.

### DETAILED DESCRIPTION

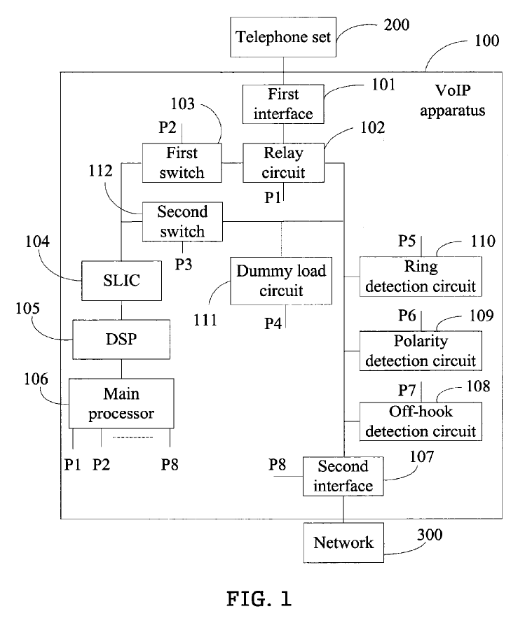

FIG. 1 is a block diagram of a voice over Internet protocol (VoIP) apparatus of an exemplary embodiment of the present invention. In the exemplary embodiment, the VoIP apparatus 100 connects a telephone set 200 to a communication network 300. In the exemplary embodiment, the VoIP apparatus 100 is a VoIP modem. The VoIP apparatus 100 may have both a VoIP service and a PSTN service provided thereto, or may only have a VoIP service provided thereto. Correspondingly, the communication network 300 may be considered to include both a VoIP phone network and a Public Switched Telephone Network (PSTN), or may be considered to include only a VoIP phone network. That is, the PSTN is considered to exist in the communication network 300 if the PSTN service is provided to the VoIP apparatus 100, and the PSTN is considered to not exist in the communication network 300 if the PSTN service is not provided to the VoIP apparatus 100. In a boot-up stage, the VoIP apparatus 100 detects whether a PSTN exists; that is, the VoIP apparatus 100 detects whether a PSTN service is provided thereto. If the PSTN service is provided, the VoIP apparatus 100 can further detect whether the PSTN service is functioning normally. In a typical application, an Internet service provider (ISP) using the communication network 300 can remotely telnet the VoIP apparatus 100 to find out about the provision or otherwise (and the functioning status) of the PSTN service.

The VoIP apparatus 100 includes a first interface 101, a relay circuit 102, a first switch 103, a subscriber line interface circuit (SLIC) 104, a digital signal processor (DSP) 105, a main processor 106, a second interface 107, an off-hook detection circuit 108, a polarity detection circuit 109, a ring detection circuit 110, a dummy load circuit 111, and a second switch 112.

In the exemplary embodiment, the main processor 106 includes a plurality of general purpose input output (GPIO) interfaces P1-P8. The interface P1 is used for communicating with the relay circuit 102, the interface P2 is used for communicating with the first switch 103, the interface P3 is used for communicating with the second switch 112, the interface P4 is used for communicating with the dummy load circuit 111, the interface P5 is used for communicating with the ring detection circuit 110, the interface P6 is used for communicating with the polarity detection circuit 109, the interface P7 is used for communicating with the off-hook detection circuit 108, and the interface P8 is used for communicating with the second interface 107.

The first interface 101 is provided between the telephone set 200 and the relay circuit 102. The relay circuit 102 is used for selectively connecting the telephone set 200 either to the SLIC 104 via the first switch 103 or to the second interface 107, according to a first control signal sent by the main processor 106. The first switch 103 is connected between the relay circuit 102 and the SLIC 104, and is used for controlling the connectivity between the relay circuit 102 and the SLIC 104 according to a second control signal sent by the main processor 106. The second switch 112 is provided between the SLIC 104 and the second interface 107, and is used for controlling the connectivity between the SLIC 104 and the second interface 107 according to a third control signal sent by the main processor 106. In the exemplary embodiment, when the relay circuit 102 connects the telephone set 200 to the SLIC 104, the second switch 112 is opened and the first switch 103 is closed, the VoIP apparatus 100 enters a VoIP mode. When the relay circuit 102 connects the telephone set 200 to the second interface 107, the VoIP apparatus 100 enters a PSTN mode. In the exemplary embodiment, when the VoIP apparatus 100 enters the PSTN mode, the first switch 103 is opened, and the second switch 112 is closed.

The SLIC 104 is connected between the relay circuit 102 and the main processor 106, and is used for converting analog voice signals received from the telephone set 200 to pulse code modulation (PCM) codes, and converting PCM codes received from the DSP 105 to analog voice signals. The DSP 105 is connected between the SLIC 104 and the main processor 106, and is used for converting PCM codes received from the SLIC 104 to real-time transport protocol (RTP) packets that are then forwarded to the main processor 106, and converting RTP packets received from the main processor 106 to PCM codes that are then forwarded to the SLIC 104. The main processor 106 is used for transmitting RTP packets received from the DSP 105 to the communication network 300 via the second interface 107, and transmitting RTP packets received from the second interface 107 to the DSP 105.

The second interface 107 is connected between the communication network 300 and the off-hook detection circuit 108. In the exemplary embodiment, the PSTN in the communication network 300 employs PSTN lines that have a tip line and a ring line. The off-hook detection circuit 108 is connected to both the second interface 107 and the relay circuit 102, and is coupled to either the tip line or the ring line of the PSTN for detecting a dial tone from the PSTN. The polarity detection circuit 109 is connected to both the second interface 107 and the relay circuit 102, and is coupled to the tip line or the ring line of the PSTN for detecting polarities of the PSTN lines. The ring detection circuit 110 is connected to both the second interface 107 and the relay circuit 102, and is coupled to the tip line and the ring line of the PSTN for detecting PSTN calls. The dummy load circuit 111 is connected to both the SLIC 104 and the second interface 107, and is controlled by the main processor 106 to couple to the tip line and the ring line of the PSTN for simulating an off-hook status of the telephone set 200. In the exemplary embodiment, when the dummy load circuit 111 is coupled to the tip line and the ring line of the PSTN, a load is added to the PSTN, which simulates the off-hook status of the telephone set 200.

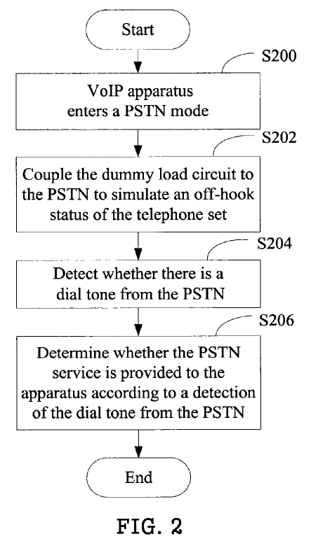

FIG. 2 is a flow chart of a method for detecting whether a PSTN service is provided to a VoIP apparatus such as the VoIP apparatus 100, in accordance with an exemplary embodiment of the present invention. In the exemplary embodiment, it is assumed that a PSTN exists in the communication network 300. Furthermore, an ISP can find out about the result of such detection by remotely telnetting the VoIP apparatus 100.

At step S200, the VoIP apparatus 100 enters a PSTN mode. In the exemplary embodiment, in a boot-up stage, the main processor 106 sends a control signals to the relay circuit 102 via the interface P1 to drive the relay circuit 102 to connect the telephone set 200 to the second interface 107. Thus, the VoIP apparatus 100 enters the PSTN mode.

At step S202, the dummy load circuit 111 is coupled to the PSTN to simulate an off-hook status of the telephone set 200. In the exemplary embodiment, the main processor 106 sends another control signal to the dummy load circuit 111, so that the dummy load circuit 111 is coupled to a tip line and a ring line of the PSTN. Then a load is added to the PSTN to simulate the off-hook status of the telephone set 200. If the PSTN exists in the communication network 300, and the PSTN is operating normally, the PSTN detects the load added by the dummy load circuit 111, and accordingly sends back a dial tone.

At step S204, the off-hook detection circuit 108 detects whether there is a dial tone from the PSTN. At step S206, the main processor 106 determines whether the PSTN service is provided to the VoIP apparatus 100 according to a detection of the dial tone from the PSTN. In the exemplary embodiment, if the off-hook detection circuit 108 detects the dial tone, the main processor 106 confirms that the PSTN exists; that is, the PSTN service is provided to the VoIP apparatus 100. If the off-hook detection circuit 108 does not detect the dial tone, the main processor 106 determines that the PSTN does not exist; that is, the PSTN service is not provided to the VoIP apparatus 100. Thereafter, in a typical application, an ISP can remotely telnet the VoIP apparatus 100 to find out about the provision or otherwise of the PSTN service.

In another exemplary embodiment, the communication network 300 includes both the VoIP network and the PSTN. That is, both the VoIP service and the PSTN service are provided to the VoIP apparatus 100. In a typical situation, a voice service is not correctly provided to the VoIP apparatus 100, and an ISP needs to determine which particular service has problems, the VoIP service or the PSTN service. In the exemplary embodiment, the VoIP apparatus 100 is restarted. Then the procedure is similar to that described above in relation to FIG. 2. During the boot-up stage, the off-hook detection circuit 108 of the VoIP apparatus 100 once again detects whether there is a dial tone from the PSTN. If the off-hook detection circuit 108 detects the dial tone, the main processor 106 determines that the PSTN service is functioning normally. If the off-hook detection circuit 108 does not detect the dial tone, the main processor 106 determines that the PSTN service is not functioning normally. Therefore, the ISP can remotely telnet the VoIP apparatus 100 to find out about the functioning status of the PSTN service, and accordingly determine which service has problems. If the PSTN service is functioning normally, the VoIP service may have one or more problems. If the PSTN service is not functioning normally, the PSTN service may have one or more problems.

While embodiments and applications of this invention have been shown and described, it should be apparent to those skilled in the art having the benefit of this disclosure that many more modifications than those mentioned above are possible without departing from the inventive concepts herein. The invention, therefore, is not to be restricted except in the spirit of the appended claims.

What is claimed is:

1. A voice over Internet protocol (VoIP) apparatus, for detecting whether a public switched telephone network (PSTN) service is provided to the apparatus, and if the PSTN service is provided, for detecting whether the PSTN service is functioning normally, the apparatus comprising:
a main processor;
a relay circuit under control of the main processor, for selectively connecting a telephone set to the main processor or to a PSTN;
a dummy load circuit for coupling to the PSTN under control of the main processor, and for simulating an off-hook status of the telephone set; and
an off-hook detection circuit for coupling to the PSTN under control of the main processor, and for detecting a dial tone from the PSTN;
wherein the main processor determines the provision or otherwise of the PSTN service and the normal functioning or otherwise of the PSTN service according to a detection or otherwise of a dial tone from the PSTN.

2. The VoIP apparatus as claimed in claim 1, wherein the dummy load circuit is for coupling to a tip line and a ring line of the PSTN.

3. The VoIP apparatus as claimed in claim 1, wherein the off-hook detection circuit is for coupling to a tip line of the PSTN.

4. The VoIP apparatus as claimed in claim 1, wherein the off-hook detection circuit is for coupling to a ring line of the PSTN.

5. The VoIP apparatus as claimed in claim 1, further comprising a first interface for connecting between the relay circuit and the telephone set.

6. The VoIP apparatus as claimed in claim 1, further comprising a second interface for connecting between the PSTN and the off-hook detection circuit.

7. The VoIP apparatus as claimed in claim 6, further comprising a subscriber line interface circuit (SLIC) connected between the relay circuit and the main processor.

8. The VoIP apparatus as claimed in claim 7, further comprising a digital signal processor connected between the SLIC and the main processor.

9. The VoIP apparatus as claimed in claim 7, further comprising a first switch connected between the relay circuit and the SLIC.

10. The VoIP apparatus as claimed in claim 7, further comprising a second switch connected between the SLIC and the second interface.

11. The VoIP apparatus as claimed in claim 7, wherein the dummy load circuit is connected to both the SLIC and the second interface.

12. The VoIP apparatus as claimed in claim 6, further comprising a polarity detection circuit connected to both the second interface and the relay circuit, and being for coupling to the PSTN for detecting a polarity of PSTN lines of the PSTN.

13. The VoIP apparatus as claimed in claim 6, further comprising a ring detection circuit connected to both the second interface and the relay circuit, and being for coupling to the PSTN for detecting PSTN calls.

14. A method for detecting a status regarding provision or otherwise of a public switched telephone network (PSTN) service to a voice over Internet protocol (VoIP) apparatus, the method comprising the steps of:
providing a dummy load circuit and an off-hook detection circuit;
entering a PSTN mode;
coupling the dummy load circuit to a PSTN to simulate an off-hook status of a telephone set;
detecting whether there is a dial tone from the PSTN by the off-hook detection circuit; and
determining whether the PSTN service is provided to the VoIP apparatus according to a detection or otherwise of a dial tone from the PSTN.

15. The method as claimed in claim 14, further comprising the steps of:
determining that the PSTN service is provided to the VoIP apparatus, if a dial tone is detected; and
determining that the PSTN service is not provided to the VoIP apparatus, if a dial tone is not detected.

16. The method as claimed in claim 15, further comprising the steps of:
determining that the PSTN service is functioning normally, if the PSTN service is provided to the VoIP apparatus and if a dial tone is detected; and
determining that the PSTN service is not functioning normally, if the PSTN service is provided to the VoIP apparatus and if a dial tone is not detected.

17. The method as claimed in claim 14, wherein the dummy load circuit is coupled to a tip line and a ring line of the PSTN, and adds a load to the PSTN to simulate the off-hook status of the telephone set.

18. The method as claimed in claim 17, wherein if the PSTN exists and is functioning normally, the PSTN detects the load added by the dummy load circuit and sends a dial tone to the VoIP apparatus.
